(19) United States
(12) Patent Application Publication
(10) Pub. No.: US 2010/0289722 A1
(43) Pub. Date: Nov. 18, 2010

(54) Portable Information Processing Apparatus

(75) Inventor: Kimiko Kitazawa, Osaka (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/863,584

(22) PCT Filed: Jan. 29, 2009
(86) PCT No.: PCT/JP2009/051441

§ 371 Date: Jul. 19, 2010

(30) Foreign Application Priority Data
Jan. 30, 2008 (JP) 2008-019732

(51) Int. Cl. H04M 1/00; G09G 5/00

(52) U.S. Cl. 345/1.1; 455/566

(57) ABSTRACT

In order to reduce power consumption and to display an image in an easily visible manner, a mobile phone includes a first process execution portion 45 and a second process execution portion 47 for executing a first process and a second process, respectively, an LCD having a first partial display region and a second partial display region for visually displaying an image, a mode switch portion 43 for switching between a first mode in which an image is visually displayed in at least one of the first partial display region and the second partial display region and a second mode in which an image is visually displayed in the entire display region of the LCD, and a display control portion 49 for visually displaying a first image and a second image output by execution of the first process and the second process, respectively, in said first partial display region and the second partial display region, respectively, if the first mode is switched on.

### TECHNICAL FIELD

The present invention relates to a portable information processing apparatus and an image display method, and more particularly to a portable information processing apparatus having a function of displaying images and an image display method executed in the portable information processing apparatus.

### BACKGROUND ART

In recent years, mobile phones have a plurality of functions such as a television receiving function and a Web site browsing function in addition to a telephone call function and are thus operated for longer time. On the other hand, mobile phones are required to be compact and lightweight for the convenience of carrying them, and the mounted batteries tend to be reduced in size, accordingly. It is therefore desirable that power consumption should be small.

As a technique for reducing power consumption of mobile phones, a mobile phone is known which is mounted with a first high-brightness backlight with large power consumption for illuminating the entire liquid crystal display and a second low-brightness backlight with small power consumption for illuminating part of the liquid crystal display so that the range illuminated by the backlight can be switched depending on purposes, that is, information displayed on the liquid crystal display or functions to be executed.

The conventional mobile phones, however, cannot always display necessary information enough because the display area is limited by illuminating only part of the liquid crystal display. For example, if two processes are executed simultaneously, for example, if a telephone call arrives while an email is being viewed, the result of only one of the processes can be displayed. Furthermore, if the displayed image has a large area, the image displayed on only part of the liquid crystal display may be hardly visible. In this case, a switching operation is needed to allow the entire liquid crystal display to be illuminated, and the operation is thus cumbersome.

### DISCLOSURE OF THE INVENTION

### Problems to be Solved by the Invention

The present invention is made in order to solve the aforementioned problem. An object of the present invention is to provide a portable information processing apparatus capable of displaying images in, a visible manner with reduced power consumption.

Another object of the present invention is to provide an image display method capable of displaying images in a visible manner with reduced power consumption.

### Means for Solving the Problems

In order to achieve the aforementioned object, in accordance with an aspect of the present invention, a portable information processing apparatus includes: process execution means for executing a plurality of processes; display means having two or more partial display regions for visually displaying an image; mode switch means for switching between a first mode in which an image is visually displayed in at least one of the two or more partial display regions and a second mode in which an image is visually displayed in an entire display region of the display means; and display control means for, if the first mode is switched on, visually displaying a first image output by execution of a first process of the plurality of processes and a second image output by execution of a second process of the plurality of processes in a first partial display region and a second partial display region, respectively, of the two or more partial display regions.

In accordance with this aspect, when the first mode is switched on, the first image and the second image output by execution of the first and second processes, respectively, of a plurality of processes are visually displayed in the first partial display region and the second partial display region, respectively, of two or more partial display regions. Therefore, consumed power can be reduced as compared with display in the entire display region. Furthermore, the user can view the results of a plurality of processes at the same time since a plurality of respective images output by execution of a plurality of processes are displayed at the same time. As a result, it is possible to provide a portable information processing apparatus capable of displaying an image in easily visible manner with reduced power consumption.

Preferably, if the first mode is switched on, the display control means visually displays the second image output by execution of the second process in the second display region when the second process is executed before a prescribed time has elapsed since the first image output by execution of the first process is visually displayed in the first partial display region, and the display control means visually displays the second image output by execution of the second process in the first partial display region when the second process is executed after the prescribed time has elapsed since the first image output by execution of the first process is visually displayed in the first partial display region.

In accordance with this aspect, before a prescribed time has elapsed since the first image is displayed, the second image is simultaneously displayed, so that the user can view a plurality of process results at the same time. On the other hand, after a prescribed time has elapsed since the first image is displayed, the second image is displayed in place of the first image, thereby reducing power consumption. Priority can be switched between reduction of power consumption and convenience depending on the timing at which an image is displayed.

In accordance with another aspect of the present invention, a portable information processing apparatus includes: display means having a partial display region for visually displaying an image partially; detection means for detecting a data amount of an image; mode switch means for switching between a first mode in which an image is visually displayed in the partial display region and a second mode in which an image is visually displayed in an entire display region of the display means, based on the detected data amount; and display control means for, if the first mode is switched on, visually displaying an image in the partial display region.

In accordance with this aspect, switching is made between the first mode and the second mode based on the data amount of an image. If the data amount of an image is large, the image is displayed in the entire display region so that the image is displayed in an easily visible manner. If the data amount of an image is small, the image is displayed in the partial display region, thereby reducing power consumption. As a result, it is possible to provide a portable information processing apparatus capable of displaying an image in easily visible manner with reduced power consumption.

Preferably, the display means has a plurality of the partial display regions. The portable information processing apparatus further includes an instruction accepting means for accepting an enlarged display instruction by a user. If the first mode is switched on, the display control means visually displays an image in one of the plurality of partial display regions, and in response to the enlarged display instruction being accepted, visually displays an image in at least two of the plurality of partial display regions.

In accordance with this aspect, an image is visually displayed in one partial display region until an enlarged display instruction is accepted, and when an enlarged display instruction is accepted, the image is displayed in at least two or more partial display regions. Therefore, the image can be displayed in an easily visible manner.

In accordance with another aspect of the present invention, a portable information processing apparatus includes: display means having a plurality of partial display regions for visually displaying an image; mode switch means for switching between a first mode in which an image is visually displayed in at least one of the plurality of partial display regions and a second mode in which an image is visually displayed in an entire display region of the display means; instruction accepting means for accepting an enlarged display instruction by a user; and display control means for, if the first mode is switched on, visually displaying an image in one of the plurality of partial display regions and, in response to the enlarged display instruction being accepted, visually displaying the displayed image in at least two of the plurality of partial display regions.

In accordance with this aspect, since an image is displayed in one partial display region until an enlarged display instruction is accepted, power consumption is reduced. Since an image is displayed in at least two or more partial display regions when an enlarge display instruction is accepted, the image can be displayed in an easily visible manner. As a result, it is possible to provide a portable information processing apparatus capable of displaying an image in an easily visible manner with reduced power consumption.

Preferably, the portable information processing apparatus further includes: a battery; and remaining capacity detection means for detecting a remaining capacity of the battery. The mode switch means switches to the first mode, if the remaining capacity detected by the remaining capacity detection means is smaller than a prescribed amount.

In accordance with this aspect, when the remaining capacity of the battery is smaller than a prescribed amount, the first mode is switched on, so that power consumption is forcedly reduced thereby realizing display for a long time.

Preferably, the display control means includes marking means for adding a prescribed mark to a displayed part of an image when all of the image is not displayed.

In accordance with this aspect, the user can be notified that all of the image is not displayed.

In accordance with a further aspect of the present invention, an image display method, which is performed in a portable information processing apparatus including display means having two or more partial display regions for visually displaying an image, includes the steps of: switching between a first mode in which an image is visually displayed in at least one of the two or more partial display regions and a second mode in which an image is visually displayed in an entire display region of the display means; and, if the first mode is switched on, visually displaying a first image output by execution of a first process and a second image output by execution of a second process in a first partial display region and a second partial display region, respectively, of the two or more partial display regions.

In accordance with this aspect, it is possible to provide an image display method capable of displaying an image in an easily visible manner with reduced power consumption.

In accordance with yet another aspect of the present invention, an image display method, which is performed in a portable information processing apparatus including display means having a partial display region for visually displaying an image partially, includes the steps of: detecting a data amount of an image; switching between a first mode in which an image is visually displayed in the partial display region and a second mode in which an image is visually displayed in an entire display region of the display means, based on the detected data amount; and, if the first mode is switched on, visually displaying an image in the partial display region.

In accordance with this aspect, it is possible to provide an image display method capable of displaying an image in an easily visible manner with reduced power consumption.

In accordance with still another aspect of the present invention, an image display method, which is performed in a portable information processing apparatus including display means having a plurality of partial display regions for visually displaying an image, includes the steps of: switching between a first mode in which an image is visually displayed in at least one of the plurality of partial display regions and a second mode in which an image is visually displayed in an entire display region of the display means; accepting an enlarged display instruction by a user: if the first mode is switched on, visually displaying an image in at least one of the plurality of partial display regions; and in response to the enlarged display instruction being accepted when an image is visually displayed in one of the plurality of partial display regions, visually displaying the displayed image in at least two of the plurality of partial display regions.

In accordance with this aspect, it is possible to provide'an image display method capable of displaying an image in an easily visible manner with reduced power consumption.

### BRIEF DESCRIPTION OF THE DRAWINGS

FIG. 1A is an external perspective view showing a mobile phone in an open style in accordance with an embodiment of the present invention.

FIG. 1B is an external perspective view showing the mobile phone in a closed style in accordance with an embodiment of the present invention.

FIG. 2 is a diagram for illustrating a plurality of partial display regions of LCD.

FIG. 3 is a functional block diagram showing exemplary functions of the mobile phone in accordance with the present embodiment.

FIG. 4 is a functional block diagram showing an overview of functions of CPU included in the mobile phone.

FIG. 5 is a first flowchart showing an exemplary flow of a display switching process.

FIG. 6 is a second flowchart showing an exemplary flow of a display control process.

FIG. 7 is a flowchart showing an exemplary flow of a display control process.

FIG. 8A is a first diagram showing an exemplary screen appearing on LCD in a first mode.

FIG. 8B is a second diagram showing an exemplary screen appearing on LCD in the first mode.

FIG. 8C is a third diagram showing an exemplary screen appearing on LCD in the first mode.

FIG. 8D is a diagram showing an exemplary screen appearing on LCD in a second mode.

FIG. 9 is a functional block diagram showing an overview of functions of CPU included in the mobile phone in a first modification.

FIG. 10 is a first flowchart showing an exemplary flow of a display switching process in the first modification.

FIG. 11A is a first diagram showing an exemplary screen appearing on LCD in the first modification.

FIG. 11B is a second diagram showing an exemplary screen appearing on LCD in the first modification.

FIG. 12 is a functional block diagram showing an overview of functions of CPU included in the mobile phone in a second modification.

FIG. 13 is a first flowchart showing an exemplary flow of a display switching process in the second modification.

FIG. 14 is a second flowchart showing an exemplary flow of a display switching process in the second modification.

### DESCRIPTION OF REFERENCE CHARACTERS

1 mobile phone, 2 display-side portion, 3 operation-side portion, 11 speaker, 13 microphone, 14 operation keys, 15 LCD, 15A first partial display region, 15B second partial display region, 15C third partial display region, 16 first light source, 17 second light source, 18 third light source, 21 CPU, 22 radio circuit, 27 card I/F, 27A flash memory, 28 codec portion, 32 RAM, 33 EEPROM, 37 battery, 41 remaining capacity detection portion, 43, 43A, 43B mode switch portion, 45 first process execution portion, 47 second process execution portion, 49, 49A, 49B display control portion, 51 marking portion, 53 timer portion, 55 data amount detection portion, 57 instruction accepting portion.

### BEST MODES FOR CARRYING OUT THE INVENTION

In the following, an embodiment of the present invention will be described with reference to the figures. In the following description, the same parts are denoted with the same reference numerals. Their names and functions are also the same. Therefore, a detailed description thereof will not be repeated.

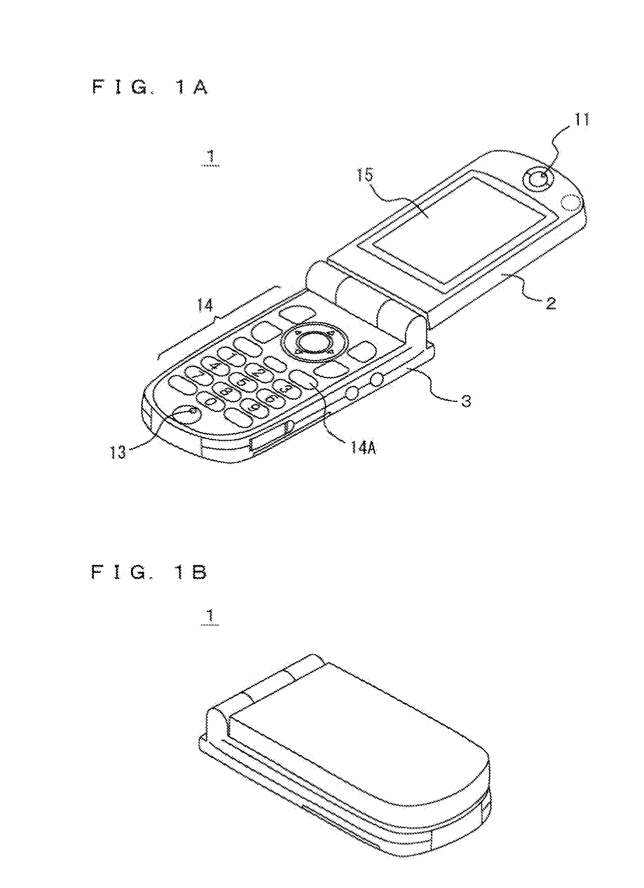

FIG. 1A and FIG. 1B are external perspective views showing a mobile phone in an embodiment of the present invention. A mobile phone 1 is an example of portable communication terminals. FIG. 1A shows an external view of the mobile phone in an open style and, FIG. 1B shows an external view of the mobile phone in a closed style. Referring to FIG. 1A and FIG. 1B, mobile phone 1 includes an operation-side portion 3 and a display-side portion 2. Operation-side portion 3 and display-side portion 2 are rotatably jointed to each other with a hinge mechanism so that operation-side portion 3 and display-side portion 2 can be opened and closed freely. When mobile phone 1 is folded and operation-side portion 3 and display-side portion 2 are in the closed state, mobile phone 1 is in the closed style. When mobile phone 1 is opened and operation-side portion 3 and display-side portion 2 are in the open state, mobile phone 1 is in the open style.

Operation-side portion 3 includes a power key 14A, operation keys 14 including ten keys, a call key and the like, and a microphone 13 arranged on the inner surface thereof. Display-side portion 2 includes a liquid crystal display (LCD) 15 and a first speaker 11, which forms a receiver, arranged on the inner surface thereof.

Mobile phone 1 includes a backlight provided on the back face of LCD 15. Passage of light emitted by the backlight allows an image appearing on LCD 15 to be visually displayed. The backlight includes a reflector provided on the back face of LCD 15 and a plurality of light sources for applying light to the reflector. A plurality of partial display regions are formed in LCD 15 by varying a combination of light sources that emit light, among the plurality of light sources.

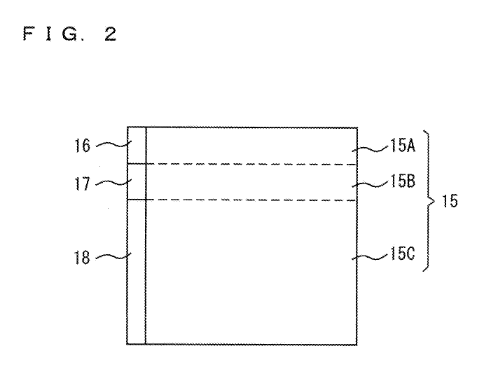

FIG. 2 is a diagram for illustrating a plurality of partial display regions of the LCD. Referring to FIG. 2, the backlight includes a reflector provided on the back face of LCD 15, and a first light source 16, a second light source 17, and a third light source 18 corresponding to a first partial display region 15A, a second partial display region 15B, and a third partial display region 15C, respectively, of LCD 15. It is noted that the dotted lines in the figure are drawn for the sake of illustration and actually do not exist. First partial display region 15A, second partial display region 15B, and third partial display region 15C constitute the entire display region 15A, 15B, 15C of LCD 15.

Light emitted from first light source 16 is reflected by the reflector and enters first partial display region 15A from the back face of the first partial display region of LCD 15. Accordingly, an image displayed in first partial display region 15A of LCD 15 can be recognized visually. Light emitted from second light source 17 is reflected by the reflector and enters the first partial display region from the back face of second partial display region 15B of LCD 15. Accordingly, an image displayed in second partial display region 15B of LCD 15 can be recognized visually. Light emitted from third light source 18 is reflected by the reflector and enters third partial display region 15C from the back face of third partial display region 15C of LCD 15. Accordingly, an image displayed on third partial display region 15C of LCD 15 can be recognized visually.

Although mobile phone 1 includes LCD 15 here, an organic EL (Electro-Luminescence) display may he used in place of LCD 15. The use of an organic EL display eliminates the need for a backlight. In the organic EL display, the smaller is the display area of the display, the less is power consumption, as is the case with LCD 15.

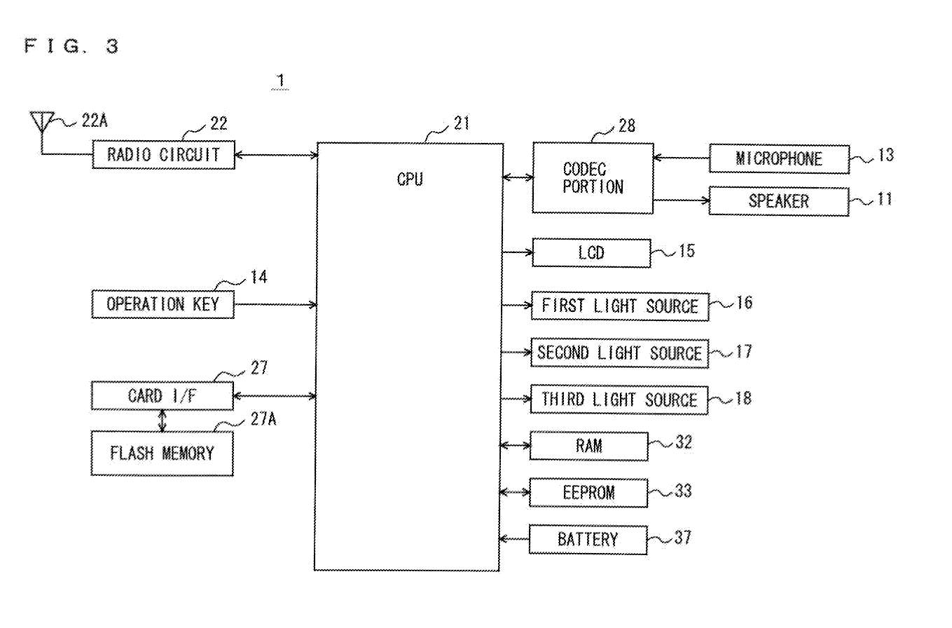

FIG. 3 is a functional block diagram showing exemplary functions of the mobile phone in accordance with the present embodiment. Referring to FIG. 3, mobile phone 1 includes a CPU 21 for controlling mobile phone 1 as a whole, a radio circuit 22 connected to an antenna 22A, a codec portion 28 for processing audio data, a microphone 13 and a speaker 11 each connected to codec portion 28, an operation key 14 accepting input of the user's operation, the liquid crystal display (LCD) 15, first light source 16, second light source 17, third light source 18, a RAM (Random Access Memory) 32 used as a work area of CPU 21, an EEPROM (Electronically Erasable and Programmable Read Only Memory) 33 for storing data, application programs, and the like in a nonvolatile manner, a card interface (I/F) 27, and a battery 37.

Radio circuit 22 receives a radio signal from antenna 22A and outputs the demodulated radio signal to CPU 21. If the modulated radio signal is an audio signal, CPU 21 outputs the audio signal to codec portion 28. Radio circuit 22 receives a signal from CPU 21 and then outputs the modulated radio signal to antenna 22A. When an audio signal is input from codec portion 28, CPU 21 outputs the audio signal to radio circuit 22.

Codec portion 28 decodes an audio signal input from CPU 21, converts the decoded digital audio signal into an analog signal, amplifies the analog signal, and then outputs the amplified signal to speaker 11. In addition, codec portion 28 receives an analog audio signal from microphone 13, converts the audio signal into a digital signal, encodes the digital signal, and then outputs the encoded audio signal to CPU 21.

Battery 37 is a secondary battery such as a lithium-ion battery, a NiCad battery, or a nickel metal hydride battery for storing electric power.

A removable flash memory 27A is attached to card I/F 27. CPU 21 can access flash memory 27A through card I/F 27. A program to be executed by CPU 21 is stored in flash memory 27A so that the program is read from flash memory 27A and executed by CPU 21. A recording medium for storing a program is not limited to flash memory 27A and may be a flexible disk, a cassette tape, an optical disk (CD-ROM (Compact Disc-ROM)/MO (Magnetic Optical Disc)/MD (Mini Disc)/DVD (Digital Versatile Disc)), an IC card, an optical card, a semiconductor memory such as a mask ROM, EPROM (Erasable Programmable ROM) or EEPROM (Electronically EPROM), or the like.

The program referred to herein includes not only a program directly executable by CPU 21 but also a source program, a compressed program, an encrypted program, and the like.

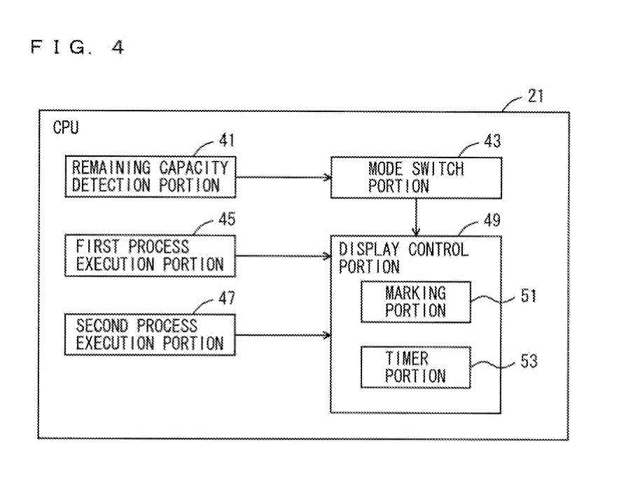

FIG. 4 is a functional block diagram showing an overview of functions of the CPU of the mobile phone. Referring to FIG. 4, CPU 21 includes a remaining capacity detection portion 41 for detecting the remaining capacity of battery 37, a mode switch portion 43 for switching display modes, a display control portion 49 for controlling display of an image, and a first process execution portion 45 and a second process execution portion 47 for executing processes.

First process execution portion 45 executes a first process and outputs an image (hereinafter referred to as the “first image”) obtained by executing the first process to display control portion 49. Here, the first process is a process of viewing emails. In this case, the first image includes an image including the content of an email.

Second process execution portion 47 executes a second process and outputs an image (hereinafter referred to as the “second image”) obtained by executing the second process to display control portion 49. Here, the second process is a process of giving a notice of an incoming telephone call. In this case, the second image includes the characters “incoming call,” the date and time, and the telephone number of the caller.

Remaining capacity detection portion 41 detects the remaining electric capacity stored in battery 37 and outputs the detected capacity to mode switch portion 43.

Mode switch portion 43 switches a display mode between a first mode and a second mode. When the user operates operation key 14 to input an instruction to switch the display mode, mode switch portion 43 switches the display mode in accordance with the input instruction. When the display mode is switched in the second mode, mode switch portion 43 switches the display mode to the first mode if the remaining capacity of the battery as detected by remaining capacity detection portion 41 is equal to or lower than a prescribed amount. Mode switch portion 43 outputs the display mode to display control portion 49.

Display control portion 49 includes a marking portion 51 for adding a prescribed mark and a timer portion 48 for counting the time. When an image is not entirely displayed and is displayed only partially, marking portion 41 adds a prescribed mark in a superimposed manner onto the displayed part of the image. The prescribed mark is a mark for notifying the user that an image that is not displayed exists and, here, a symbol formed of three characters “>>>.”

When a display mode indicating the first display mode is input from mode switch portion 43, tinier portion 53 measures the elapsed time since the first image is displayed in first partial display region 15A.

When a display mode indicating the first display mode is input from mode switch portion 43, display control portion 49 drives the first light source and displays the first image output from first process execution portion 45, in the first partial display region. Then, when the second image is input from second process execution portion 47 while the first image is being displayed, the second image is displayed in either first partial display region 15A or second partial display region 15B, depending on the time measured by timer portion 53. When the second image is displayed in second partial display region 15B, display control portion 49 activates second light source 17.

Specifically, if the time measured by timer portion 53 is a prescribed time, for example, 15 seconds or longer, the first image is displayed over 15 seconds to allow the user to grasp the contents of the first image. Therefore, display control portion 49 displays the second image in first partial display region 15A in place of the first image after the first image is displayed for a prescribed time. As a result, power consumption can be reduced because the image is displayed only in first partial display region 15A.

On the other hand, if the time measured by timer portion 53 is shorter than a prescribed time, display control portion 49 drives second light source 17 and displays the second image in second partial display region 15B. Specifically, the first image representing the content of an email is visually displayed in first partial display region 15A, and if an incoming call arrive before a lapse of a prescribed time, the second image for giving a notice of the incoming call is visually displayed in second partial display region 15B. Accordingly, the user can see the first image and the second image at the same time, thereby improving convenience. In addition, power consumption can be reduced as compared with the second mode in which images are visually displayed in the entire display region 15A, 15B, 15C, because third light source 18 is not driven.

When a display mode indicating, the second mode is input from mode switch portion 43, display control portion 49 drives first light source 16, second light source 16, and third light source 17 and visually displays the first image output from first process execution portion 45 in the entire display region 15A, 15B, 15C. Then, when the second image is input from second process execution portion 47 while the first image is being displayed, the second image is visually displayed in the entire display region 15A, 15B, 15C, in place of the first image.

In the second mode, all of first light source 16, second light source 17, and third light source 18 are driven, whereas in the first mode, at least one of first light source 16 and second light source 17 is driven and third light source 18 is not driven. Therefore, power consumption in the first mode is smaller than power consumption in the second mode.

In a case where an organic EL (Electro-Luminescence) display is used in place of LCD 15, the area in which an image is displayed is smaller in the second mode than in the first mode, and therefore, power consumption in the first mode is smaller than power consumption in the second mode, as is the case with LCD 15. Therefore, it is preferable that the display mode is switched to the first mode whenever possible in order to reduce power consumption also in the organic EL display.

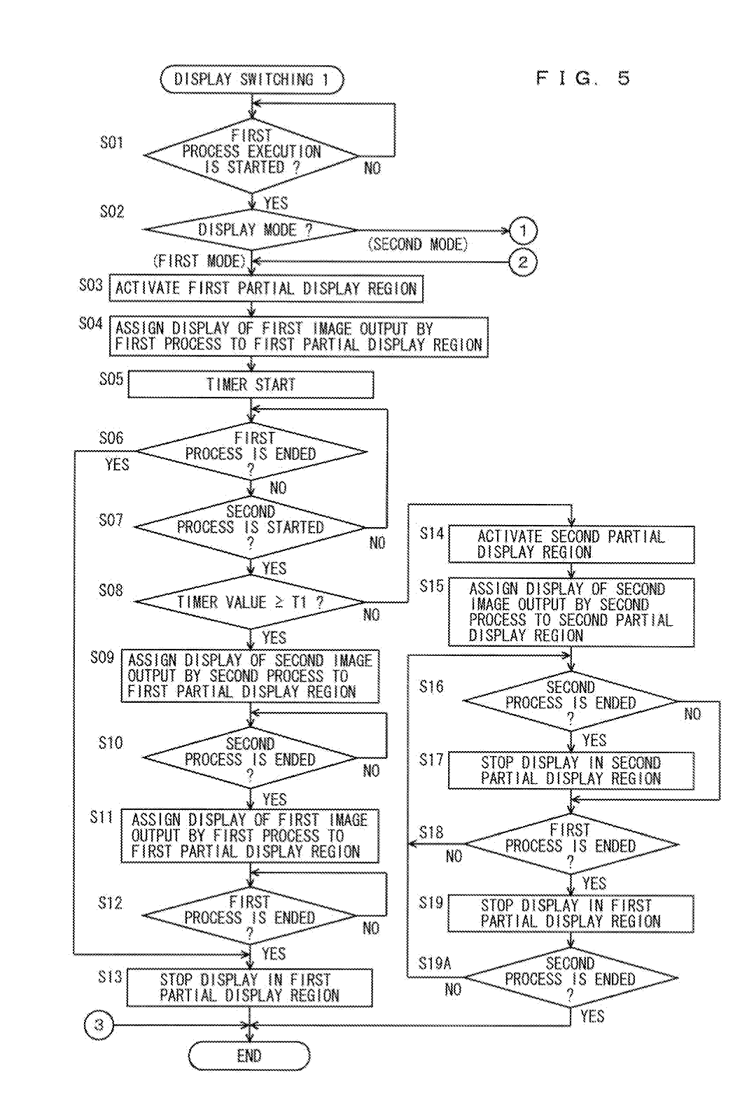

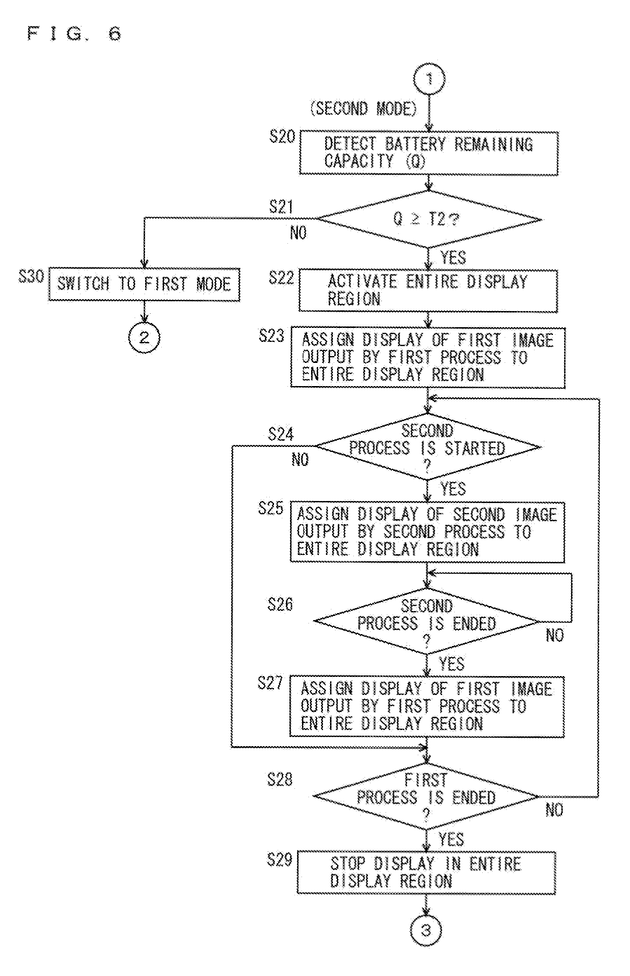

FIG. 5 and FIG. 6 are flowcharts showing an exemplary flow of a display switching process. The display switching process is a process executed by CPU 21 when CPU 21 executes an image display program. Referring to FIG. 5, CPU 21 determines whether the first process has been executed or not (step S01). The process waits until the first process is executed (NO in step S01), and when the first process is executed, the process proceeds to step S02. The first process here is an email viewing process, and therefore it is determined that the first process is executed when a program for viewing emails is executed.

In step S02, the display mode is determined. If the display mode is switched in the first mode, the process proceeds to step S03. If the display mode is switched in the second mode, the process proceeds to step S20. In step S03, first partial display region 15A is activated. Here, first light source 16 is driven. In the next step S04, display of the first image output by execution of the first process is assigned to first partial display region 15A. Accordingly, the first image output by execution of the first process is visually displayed in first partial display region 15A.

In step S05, the timer is started. The timer counts the time since the first image is displayed in first partial display region 15A. In the next step S06, it is determined whether the first process is ended or not. Here, it is determined whether the process of viewing an email is ended or not. If an instruction to end the first process is detected, the process proceeds to step S13, and if not, the process proceeds to step S07. In step S13, display of first partial display region 15A is stopped, and the process then ends. In this case, driving of first light source 16 is stopped.

If it is determined that the first process is not ended in step S06, whether the second process is executed or not is determined in the next step S07. It is determined whether the second process is executed or not during execution of the first process. If it is detected that the second process is executed, the process proceeds to step S08, and if not, the process returns to step S06. The second process here is the process of giving a notice of an incoming telephone call, and therefore it is determined whether an incoming telephone call is detected or not.

In step S08, it is determined whether the timer value is a threshold value T1 or more. In other words, it is determined whether threshold T1 time or longer has elapsed or not since the first image is displayed in first partial display region 15A. If threshold value T1 or longer has elapsed, the process proceeds to step S09, and if not, the process proceeds to step S14.

In step S09, display of the second image output by execution of the second process is assigned to first partial display region 15A. Accordingly, the second image is visually displayed in first partial display region 15A. Threshold T1 time is set to allow enough time for the user to see the first image and grasp the content. Therefore, it is no problem with the user's convenience if the second image is displayed in place of the first image after a lapse of threshold T1 time. Here, threshold value T1 is set to 15 seconds. Furthermore, power consumption can be reduced since the image is displayed only in first partial display region 15A.

In step S10, it is determined whether the second process is ended or not. The process waits until the second process is ended (NO in step S10), and when the second process is ended (YES in step S10), the process proceeds to step S11. In step S11, display of the first image output by execution of the first process is assigned to first partial display region 15A. This is to display the first image again since the first process is still being executed even when the second process is ended. Therefore, the user can see again the first image output by the first process that has been in progress, here, the image including the content of an email, after the second process is ended, here, after the call is ended.

In step S12, it is determined whether the first process is ended or not. The process waits until the first process is ended (NO in step S12). If the first process is ended, the process proceeds to step S13. In step S13, display in first partial display region 15A is stopped, and the process then ends. In the absence of an image to be displayed on LCD 15, first light source 16 is not driven, thereby minimizing power consumption.

On the other hand, in step S14, second partial display region 15B is activated. Specifically, second light source 17 is driven. In the next step S15, display of the second image output by execution of the second process is assigned to second partial display region 15B. Accordingly, the second image output by execution of the second process is visually displayed in second partial display region 15B. Therefore, two images output by execution of two respective processes are displayed simultaneously, so that the user can see the results of two processes at the same time, thereby improving the convenience.

In step S16, it is determined whether the second process is ended or not. If the second process is ended, the process proceeds to step S17. If the second process is not ended, step S17 is skipped and the process then proceeds to step S18. In step S17, display in second partial display region 15B is stopped, and the process proceeds to step S18. Specifically, display of the second image in second partial display region 15B is stopped, and in addition, driving of second light source 17 is stopped. Since second light source 17 is not driven, power consumption can be reduced. It is noted that if display in second partial region 15B has already been stopped, the process proceeds to step S18 without doing anything.

In step S18, it is determined whether the first process is ended or not. If the first process is ended, the process proceeds to step S19. If the first process is not ended, the process returns to step S16. In step S19, display in first partial display region 15A is stopped, and the process proceeds to step S19A. Specifically, display of the first image in first partial display region 15A is stopped, and driving of first light source 16 is stopped. Since first light source 16 is not driven, power consumption can be reduced. If display in first partial region 15A has already been stopped, the process proceeds to step S19A without doing anything.

In step S19A, it is determined whether the first process is ended or not. If the first process is ended, the process ends. If the first process is not ended, the process returns to step S16.

On the other hand, in the case where the process proceeds to step S20, the display mode is switched in the second mode. If the display mode is the second mode, first, the remaining capacity Q of battery 37 is detected (step S20). Then, it is determined whether the remaining capacity Q of battery 37 is equal to or greater than a threshold value T2 or not (step S21). If the remaining capacity Q of battery 37 is equal to or greater than threshold value T2, the process proceeds to step S22. If not, the process proceeds to step S30. In step S30, the display mode is switched to the first mode, and the process proceeds to step S03. If the remaining capacity Q of battery 37 is smaller than the predetermined threshold value T2, the display mode is forcedly switched to the first mode. This reduces power consumption for displaying images in a state in which the remaining capacity of the battery is low, thereby allowing mobile phone 1 to be used as long as possible.

In step S22, the entire display region 15A, 15B, 15C is activated. Specifically, first light source 16, second light source 17, and third light source 18 are driven. In step S23, display of the first image output by execution of the first process is assigned to the entire display region 15A, 15B, 15C. Accordingly, the first image is visually displayed in the entire display region 15A, 15B, 15C. Then, it is determined whether the second process is executed or not. If the second process is executed, the process proceeds to step S25, and if not, the process proceeds to step S28.

In step S25, display of the second image output by execution of the second process is assigned to the entire display region. Accordingly, the second image output by execution of the second process is visually displayed on the entire display region 15A, 15B, 15C. Since the second image is displayed in the wide area, the second image is displayed in an easily visible manner.

In step S26, it is determined whether the second process is ended or not. The process waits until the second process is ended (NO in step S26). If the second process is ended (YES in step S26), the process proceeds to step S27. In step S27, display of the first image output by execution of the first process is assigned to the entire display region 15A, 15B, 15C. This is to display the first image again since the first process is still being executed even when the second process is ended. Therefore, the user can see again the image output by the first process that has been in progress, here, the image including the content of an email, after the second process is ended, here, after the call is ended.

In step S28, it is determined whether the first process is ended or not. If the first process is ended (YES in step S28), the process proceeds to step S29. If the first process is not ended (NO in step S28), the process returns to step S24. In step S29, display in the entire display region 15A, 15B, 15C is stopped, and the process then ends. Specifically, driving of first light source 16, second light source 17, and third light source 18 is stopped, and the process then ends. In the absence of an image to be displayed on LCD 15, first light source 16, second light source 17, and third light source 18 are not driven, thereby reducing power consumption.

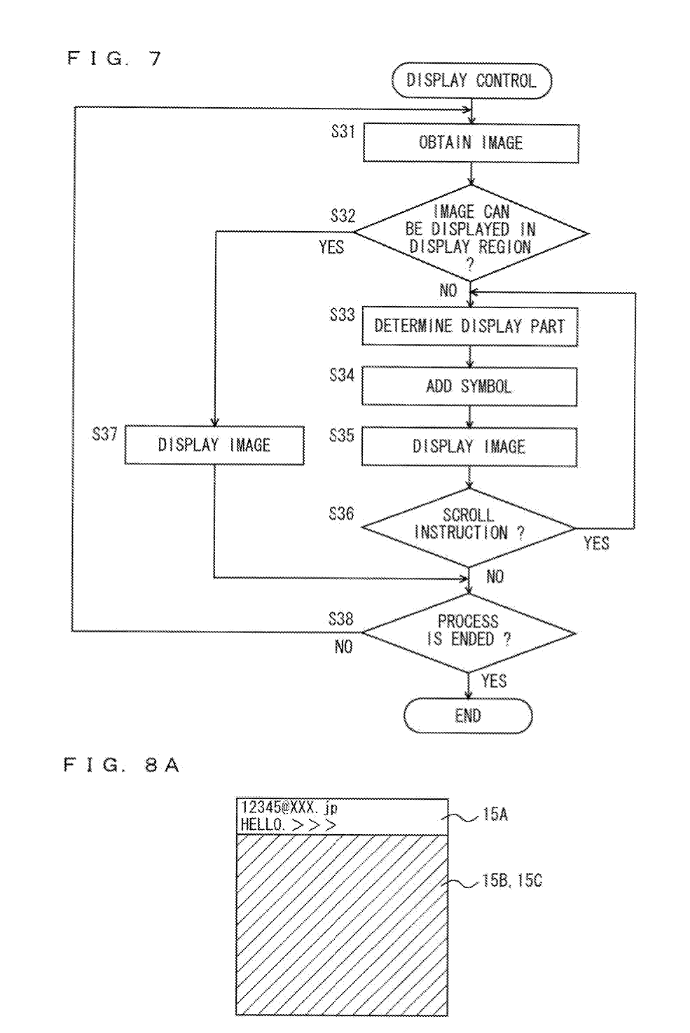

FIG. 7 is a flowchart showing an exemplary flow of a display control process. The display control process is a process executed by CPU 21 when CPU 21 executes an image display program. Furthermore, the display control process is a process executed when the first image or the second image output by execution of the first process or the second process is displayed in first display region 15A, second partial display region 15B, or the entire display region 15A, 15B, 15C, which are assigned to display the image. Here, for the sake of illustration, the one that is assigned to display an image, among first display region 15A, second partial display region 15B, and the entire display region 15A, 15B, 15C, is called a display region, and a process of displaying an image in the display region will now be described here.

Referring to FIG. 7, CPU 21 obtains an image to be displayed (step S31). The image to be displayed is the first image output by execution of the first process or the second image output by execution of the second process. Then, it is determined whether all of the obtained image can be displayed in the display region or not (step S33). The size of the obtained image is compared with the image size of the display region. If the size of the obtained image is equal to or smaller than the image size of the display region, it is determined that display is possible. If display is possible, the process proceeds to step S37. If display is impossible, the process proceeds to step S33. In step S37, the image obtained in step S31 is displayed in the display region, and the process proceeds to step S38.

In step S33, a display part to be displayed is determined from the image obtained as a display target in step S31. For example, a few lines from the top of the image are determined as the display part. Then, a symbol is added to the end of the display part (step S34). Specifically, a symbol is overwritten in the last line of the display part. The symbol is a mark indicating that the image continues below, and here is a mark formed of three characters “>>>.”

Then, the image of the display part is displayed in the display region (step S35). In step S36, it is determined whether a scroll instruction for changing the display part is accepted or not. If a scroll instruction is accepted, the process returns to step S33. If not accepted, the process proceeds to step S38. In step S33, a display part after scrolling is determined.

In step S38, it is determined whether the process is ended or not. If the process is ended, the process ends. If not, the process returns to step S31.

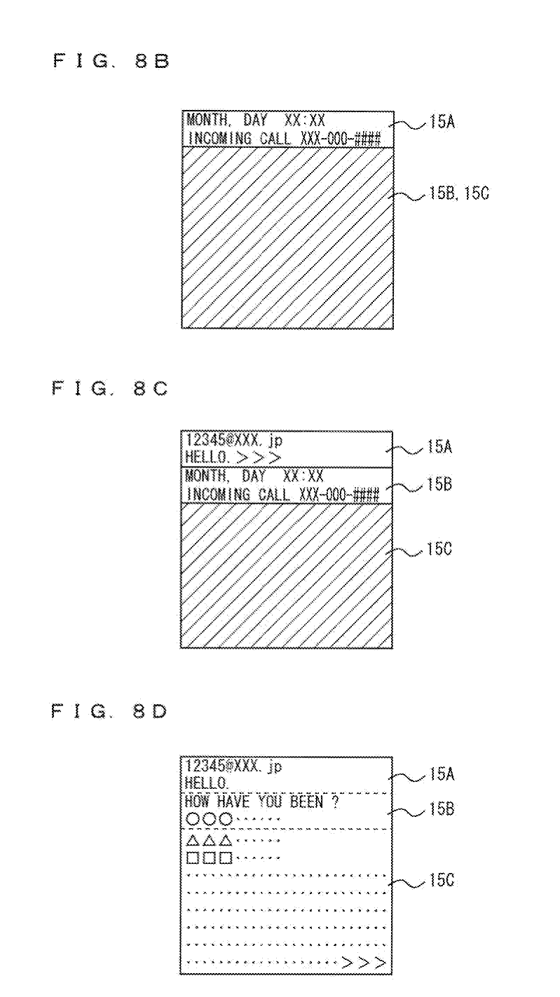

FIG. 8A-FIG. 8D are diagrams showing examples of a screen appearing on the LCD. It is noted that the dotted lines in the figures are drawn for the sake of illustration and actually do not exist. FIG. 8A is a first diagram showing an example of a screen appearing on the LCD in the first mode. FIG. 8A shows a screen appearing on LCD 15 when an email viewing process is executed as the first process. The first image including the content of an email is displayed only in first partial display region 15A. The display part of the first image is displayed in first partial display region 15A, and the display part includes the symbol “>>>” at the end. This can notify the user that the first image is not displayed below. The user can see that part of the first image which is not displayed, by performing a scrolling operation.

FIG. 8B is a second diagram showing an example of a screen displayed on the LCD in the first mode. FIG. 8B shows a screen appearing on LCD 15 when a telephone call arrives after a lapse of 15 seconds since the screen shown in FIG. 8A is displayed, and a process of giving a notice of an incoming call is executed as the second process. The second image is displayed only in first partial display region 15A to give a notice of an incoming telephone call. The second image includes, the year, month and day, the time, the characters “incoming call,” and the telephone number of the caller.

FIG. 8C is a third diagram showing an example of a screen appearing on the LCD in the first mode. FIG. 8C shows a screen appearing on LCD 15 when a telephone call arrives before a lapse of 15 seconds since the screen shown in FIG. 8A is displayed, and a process of giving a notice of an incoming call is executed as the second process. The first image is displayed in first partial display region 15A, and the second image is displayed in second display region 15B. Conveniently, the user can see the first image and the second image at the same time. Furthermore, the display part of the first image is displayed in first partial display region 15A, and the display part includes the symbol “>>>” at the end. Also on this screen, the user can see that part of the first image which is not displayed, by performing a scrolling operation.

FIG. 8D is a diagram showing an example of a screen appearing on the LCD in the second mode. FIG. 8D shows a screen appearing on LCD 15 when an email viewing process is executed as the first process. The first image including the content of an email is displayed in the entire display region 15A, 15B, 15C. Furthermore, the display part of the first image is displayed in the entire display region 15A, 15B, 15C, and the display part includes the symbol “>>>” at the end. This can notify the user that the first image is not displayed below. The user can see that part of the first image which is not displayed, by performing a scrolling operation. Since the first image is displayed in the wide area, the first image is displayed in an easily visible manner, and the frequency of the operation of scrolling the screen by the user can be decreased.

As described above, according to mobile phone 1 in the present embodiment, in the case where the display mode is switched in the first mode, the two first image and second image output by execution of the first and second processes are visually displayed in first partial display region 15A and second partial display region 15B, respectively. Therefore, the consumed power can be reduced as compared with display in the entire display region 15A, 15B, 15C. Furthermore, since a plurality of respective images output by execution of the first and second processes are displayed at the same time, the user can view the results of a plurality of processes at the same time.

Furthermore, the second image is displayed in second partial display region 15B before a prescribed time (15 seconds) elapses since the first image is displayed in first partial display region 15A. The first image and the second image are displayed at the same time, so that the user can view them at the same time. On the other hand, after a prescribed time (15 seconds) has elapsed since the first image is displayed in first partial display region 15A, the second image is displayed in place of the first image in second partial display region 15B. Since the image is displayed only in first partial display region 15A, power consumption can be reduced. Priority can be switched between reduction of power consumption and convenience depending on the timing at which an image is displayed. Therefore, power consumption can be reduced while convenience can be improved.

In addition, in the case where the display mode is switched in the second mode, when the remaining capacity of the battery is a prescribed amount or lower, the display mode is forcedly switched to the first mode, thereby forcedly reducing power consumption and realizing display for a long time.

Moreover, when all of the image is not displayed, the symbol “>>>” is added to the displayed part of the image, so that the user can be notified that all of the image is not displayed.

### <First Modification>

A first modification of mobile phone 1 will now be described. In the following, the differences from the aforementioned mobile phone 1 will mainly be described.

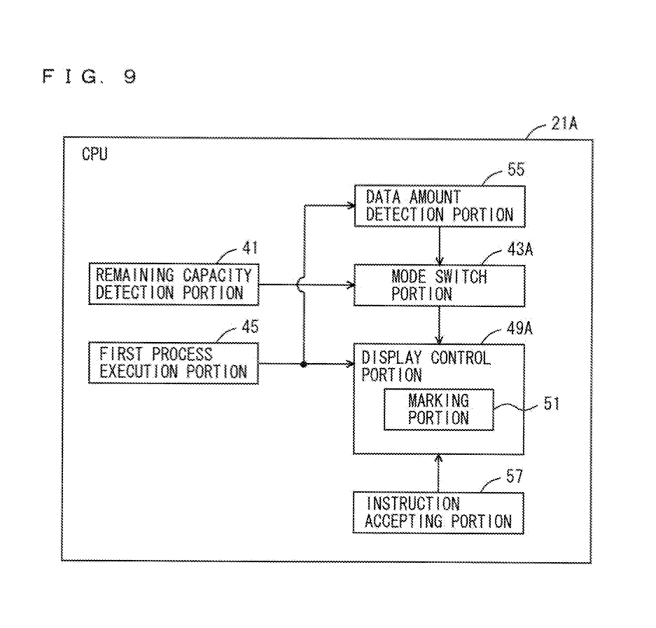

FIG. 9 is a functional block diagram showing an overview of functions of CPU of the mobile phone in the first modification. The same functions as the functions shown in FIG. 4 are denoted with the same reference numerals. The differences from the functions shown in FIG. 4 will mainly be described below. Referring to FIG. 9, CPU 21 includes remaining capacity detection portion 41 for detecting the remaining capacity of battery 37, a mode switch portion 43A for switching a display mode, a data amount detection portion 55 for detecting the amount of data of an image, a display control portion 49A for controlling display of an image, first process execution portion 45, and an instruction accepting portion 57 for accepting an instruction.

First process execution portion 45 executes a process and outputs an image obtained by execution of the process to display control portion 49A and data amount detection portion 55. Here, the first process is a process of viewing an email, and the image output by the first process execution portion executing the first process includes an image including the content of an email. Data amount detection portion 55 executes the data amount of the image output by first process execution portion 45 executing the process and outputs the detected data amount to mode switch portion 43A.

Mode switch portion 43A switches the display mode between the first mode and the second mode. Mode switch portion 43A switches the display mode based on the data amount input from data amount detection portion 55 and outputs the display mode to display control portion 49A. Specifically, if the data amount is smaller than a predetermined threshold value T3, the display mode is switched to the first mode. If the data amount is equal to or greater than the predetermined threshold value T3, the display mode is switched to the second mode. Although threshold value T3 can be set to any value, it is preferably set, for example, to the data amount of an image having the same size as the entire display region 15A, 15B, 15C of LCD 15. If the image has such a size that cannot be displayed at one time in the entire display region 15A, 15B, 15C, the display mode is switched to the second mode, so that the number of times of scrolling can be reduced, thereby improving the operability.

Mode switch portion 43A switches to the first mode if the battery remaining capacity input from remaining capacity detection portion 41 is equal to or less then threshold value T2 even when the data amount is equal to or greater than threshold value T3. This is to reduce power consumption when the battery remaining capacity is small, thereby enabling mobile phone 1 to be used as long as possible.

Display control portion 49A displays an image input from first process execution portion 45 on LCD 15 in accordance with the display mode input from mode switch portion 43A. When the display mode indicating the first mode is input from mode switch portion 43, display control portion 49A displays the image input from first process execution portion 45 in at least one of first partial display region 15A and second partial display region 15B of LCD 15. Specifically, in the first mode, display control portion 49A drives first light source 16 and second light source 17 in one of a pattern of driving first light source 16 and a pattern of driving both of first light source 16 and second light source 17. Therefore, in the first mode, an image is displayed in two patterns in which an image is visually displayed only in first partial display region 15A and in which an image is displayed in first partial display region 15A and second partial display region 15B. By default, display control portion 49A drives first light source 16 and displays an image in first partial display region 15A. Since only first light source 16 is driven, power consumption can be reduced as much as possible.

In the case where an organic EL (Electro-Luminescence) display is used in place of LCD 15, the display area in which an image is displayed is smaller in the second mode than in the first mode. Therefore, as is the case with LCD 15, power consumption in the second mode is smaller than power consumption in the second mode. Therefore, it is preferable to switch the display mode to the first mode whenever possible in order to reduce power consumption.

Display control portion 49A includes marking portion 51. When all of an image output by first process execution portion 45 is not displayed in first partial display region 15A, second partial display region 15B, or the entire display region 15A, 15B, 15C, which are assigned for display of the image, marking portion 51 adds a prescribed mark in a superimposed manner onto the displayed part of the image.

When the user operates operation key 14 assigned for an enlarged display instruction to enlarge the display region, instruction accepting portion 57 accepts the enlarged display instruction. When accepting the enlarged display instruction, instruction accepting portion 57 outputs the enlarged display instruction to display control portion 49A.

In the case where the display mode indicating the first mode is input from mode switch portion 43A, display control portion 49A displays an image in first partial display region 15A. When the enlarged display instruction is input from instruction accepting portion 57 later, display control portion 49A drives second light source 17 to display, in second partial display region 15B, that part of the image displayed in first partial display region 15A which has not been displayed yet. Accordingly, the area in which an image is visually displayed can be increased, so that the image can be displayed in an easily visible manner.

On the other hand, in the case where the display mode indicating, the second mode is input from mode switch portion 43A, display control portion 49A displays the image input from first process execution portion 45 in the entire display region 15A, 15B, 15C of LCD 15. Display control portion 49A drives first light source 16, second light source 17, and third light source 18 in the second mode. Therefore, in the second mode, all of light source 16, second light source 17, and third light source 18 are driven, whereas in the first mode, at least one of first light source 16 and second light source 17 is driven and third light source 18 is not driven. As a result, power consumption in the second mode is larger than power consumption in the first mode.

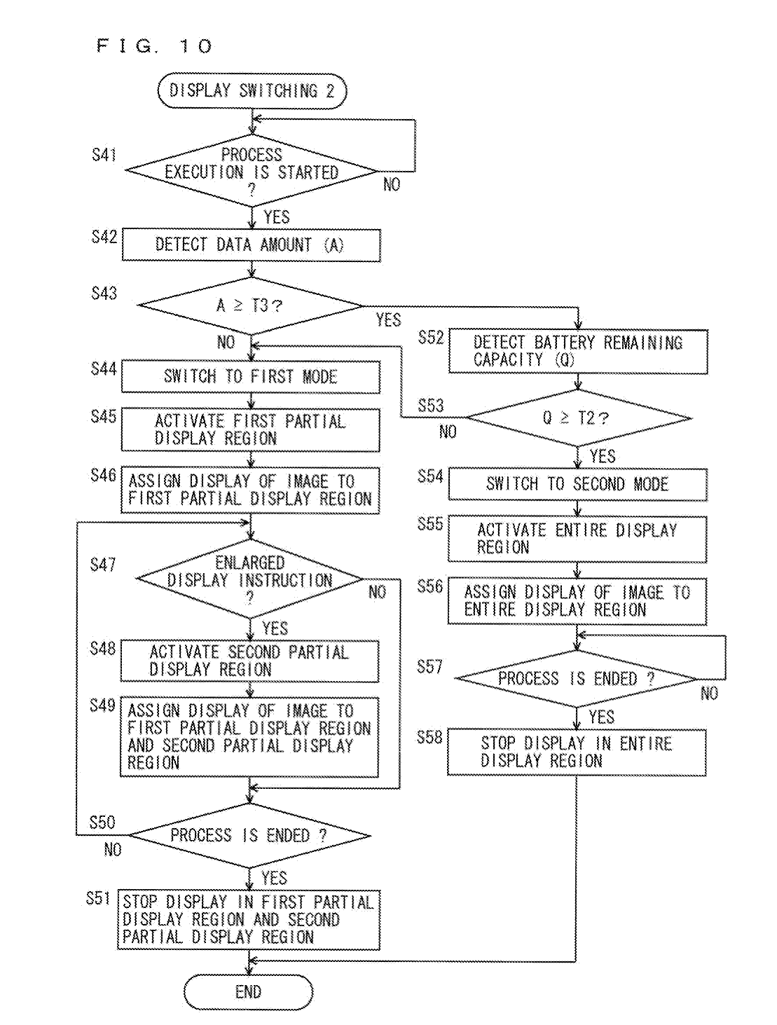

FIG. 10 is a first flowchart showing an exemplary flow of a display switching process in the first modification. The display switching process in the first modification is a process executed by CPU 21A when CPU 21A executes an image display program. Referring to FIG. 10, CPU 21 determines whether a process has been executed or not (step S41). The process waits until a process is executed (NO in step S41). If the process is executed (YES in step S41), the process proceeds to step S42.

In step S42, the data amount A of an image output by execution of the process is detected. In the next step S43, it is determined whether data amount A is equal to or greater than threshold value T3. If equal to or greater than threshold value T3, the process proceeds to step S52, and if not, the process proceeds to step S44. In step S44, the display mode is switched to the first mode, and the process then proceeds to step S45.

In step S45, first partial display region 15A is activated. Specifically, first light source 16 is driven. Then, display of the image output by execution of the process is assigned to first partial display region 15A (step S46). Accordingly, the image output by execution of the process is visually displayed in first partial display region 15A.

In the next step S47, it is determined whether the enlarged display instruction is accepted or not. If the enlarged display instruction is accepted, the process proceeds to step S48, and if not, the process proceeds to step S50. In step S48, second partial display region 15B is activated. Specifically, second light source 17 is driven. Then, the image output by execution of the process is assigned to first partial display region 15A and second partial display region 15B. Since first light source 16 and second light source 17 are driven, the image is visually displayed in first partial display region 15A and second partial display region 15B. Therefore, the user can see the image in the area wider than first partial display region 15A.

In the next step S50, it is determined whether the process is ended or not. If the process is ended, the process proceeds to step S51, and if not, the process returns to step S47. In step S51, display of the image in first partial display region 15A and second partial display region 15B is stopped, and the process then ends. Specifically, driving of first light source 16 and second light source 17 is stopped.

On the other hand, in step S52, the remaining capacity Q of battery 37 is detected. Then, it is determined whether the battery remaining capacity Q is equal to or greater than threshold value T2. If the remaining capacity Q of battery 37 is equal to or greater than threshold value T2, the process proceeds to step S54, and if not, the process proceeds to step S44. When the remaining capacity of battery 37 is small, the display mode is switched to the first mode, thereby making mobile phone 1 usable as long as possible.

If the remaining capacity Q of battery 37 is equal to or greater than threshold value T2, the display mode is switched to the second mode (step S54). Then, the entire display region 15A, 15B, 15C is activated (step S55). Specifically, first light source 16, second light source 17, and third light source 18 are driven. Then, display of the image is assigned to the entire display region 15A, 15B, 15C (step S56). Accordingly, the image output by execution of the process is visually displayed in the entire display region 15A, 15B, 15C.

In step S57, it is determined whether the process is ended or not. The process waits until the process is ended (NO in step S57). If the process is ended (YES in step S57), the process proceeds to step S58. In step S58, display in the entire display region 15A, 15B, 15C is stopped, and the process ends. Specifically, driving of first light source 16, second light source 17, and third light source 18 is stopped.

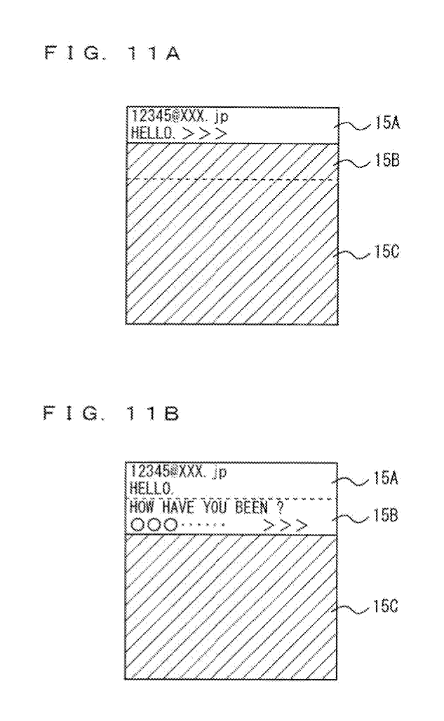

FIG. 11A and FIG. 11B are diagrams showing examples of a screen appearing on the LCD in the first modification. It is noted the dotted lines in the figures are drawn for the sake of illustration and actually do not exist. FIG. 11A is a first diagram showing an example of a screen appearing on the LCD in the first modification. FIG. 11A shows a screen appearing on LCD 15 when an email viewing process is executed as the first process in the first mode. An image including the content of an email is displayed only in first partial display region 15A.

FIG. 11B is a second diagram showing an example of a screen appearing on the LCD in the first modification. FIG. 11B shows a screen appearing on LCD 15 when an enlargement instruction is accepted in a state in which the screen shown in FIG. 11A appears. An image is displayed in first partial display region 15A and second partial display region 15B. Display in two lines is enlarged to display in four lines, thereby improving visibility of the content of the email.

If the size of the image is larger than the entire display region 15A, 15B, 15C, the display mode is switched to the second mode, so that the same screen as shown in FIG. 8D appears on LCD 15.

Mobile phone 1 in the first modification can switch between the first mode and the second mode based on the data amount of an image. If the data amount of an image is large, the image is displayed in the entire display region so that the image can be displayed in an easily visible manner. On the other hand, if the data amount of an image is small, the image is displayed in first partial display region 15A thereby reducing power consumption. The areas in which images are displayed are switched depending on the data amount of the images, so that reduction of power consumption and convenience can be switched depending on the data amount.

In the case where the display mode is switched in the first mode, an image is displayed in first partial display region 15A until an enlarged display instruction is accepted, and when an enlarged display instruction is accepted, the image is visually displayed in first partial display region 15A and second partial display region 15B, so that the image can be displayed in an easily visible manner. The area in which an image is displayed can be changed by the user's instruction.

In the first modification, an image is displayed in first partial display region 15A when the display mode is switched in the first mode. However, an image may be displayed in any one of first partial display region 15A, second partial display region 15B, and third partial display region 15C or in two regions selected from them. Furthermore, the one in which an image is displayed may be determined from among first partial display region 15A, second partial display region 15B, and third partial display region 15C, depending on the data amount of the image. A combination of second partial display region 15B and third partial display region 15C provides a display area larger than a combination of first partial display region 15A and second partial display region 15B. Therefore, in some cases, the combination of second partial display region 15B and third partial display region 15C may provide display of the entire image even when the combination of first partial display region 15A and second partial display region 15B cannot provide display of the entire image. In such a case, display of an image in second partial display region 15B and third partial display region 15C eliminates the need for a scrolling operation and is thus convenient. In addition, power consumption can be reduced since first light source 16 is not driven.

<Second Modification>

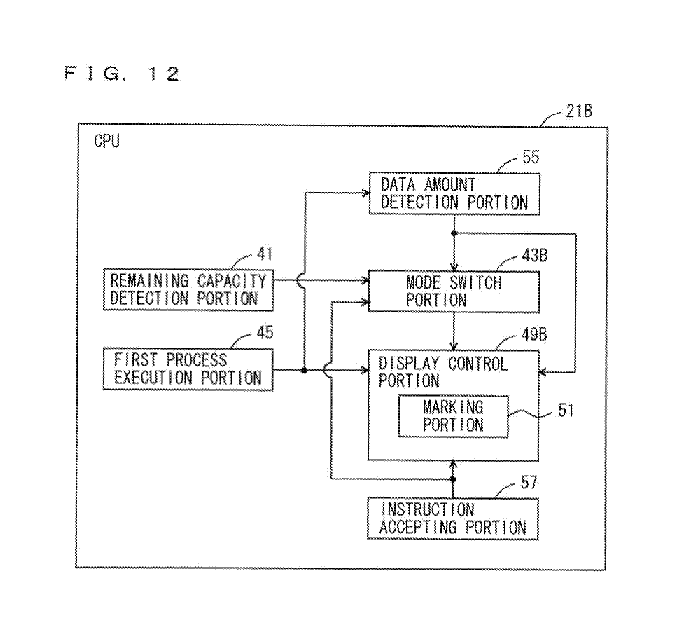

FIG. 12 is a functional block diagram showing an overview of functions of the CPU of the mobile phone in a second modification. It differs from the functional block diagram shown in FIG. 9 in that it is changed in a mode switch portion 43B and a display control portion 49B. The differences from the functions shown in FIG. 9 will mainly be described below.

When the user operates operation key 14 assigned for an enlarged display instruction to enlarge the display region, instruction accepting portion 57 accepts the enlarged display instruction. When accepting the enlarged display instruction, instruction accepting portion 57 outputs the enlarged display instruction to mode switch portion 43B and display control portion 49B.

Mode switch portion 43B switches the display mode to one of the first mode and the second mode. By default, mode switch portion 43B switches the display mode to the first mode and outputs the display mode to display control portion 49B. When the enlarged display instruction is input from instruction accepting portion 57, mode switch portion 43B switches the display mode to the second mode based on the data amount input from data amount detection portion 55 and outputs the display mode to display control portion 49B. Specifically, if the data amount is smaller than the predetermined threshold value T3, the display mode is switched to the first mode, and if the data amount is equal to or greater than the predetermined threshold value T3, the display mode is switched to the second mode. Threshold value T3 can be set to any value and is preferably set, for example, to the data amount of an image having the same size as the size of the entire display region 15A, 15B, 15C of LCD 15. If an image has such a size that cannot be displayed at one time in the entire display region 15A, 15B, 15C, the display mode is switched to the second mode, so that the number of times of scrolling can be reduced, thereby improving the operability.

Mode switch portion 43B switches to the first mode if the battery remaining capacity input from remaining capacity detection portion 41 is equal to or less then threshold value T2 even when the data amount is equal to or greater than threshold value T3. This is to reduce power consumption when the remaining battery capacity is small, thereby enabling mobile phone 1 to be used as long as possible.

Display control portion 49B visually displays an image input from first process execution portion 45 on LCD 15 in accordance with the display mode input from mode switch portion 43B. When the display mode indicating the first mode is input from mode switch portion 43, display control portion 49B drives first light source 16 and displays the image input from first process execution portion 45 in first partial display region 15A of LCD 15. Therefore, the image is visually displayed only in first partial display region 15A. By default, display control portion 49B drives only first light source 16, so that power consumption can be reduced as much as possible.

In the case where the display mode indicating the first mode is input from mode switch portion 43B, display control portion 49B displays an image in first partial display region 15A. Then, when an enlarged display instruction is input from instruction accepting portion 57 later, display control portion 49B visually displays the image in second partial display region 15B based on the data amount input from data amount detection portion 55. Specifically, if the data amount is equal to or greater than a predetermined threshold value T4, second light source 17 is driven, and the image is displayed in first partial display region 15A and second partial display region 15B. Threshold value T4 is a value smaller than threshold value T3. Here, threshold value T4 is set to the same value as the data amount of an image having the same size as the size of a region corresponding to first partial display region 15A plus second partial display region 15B. Accordingly, the image is visually displayed in first partial display region 15A and second partial display region 15B.

On the other hand, if the data amount of an image is smaller than threshold value T4, display control portion 49A does not drive second light source 17. Threshold value T4 can be set to any value and is preferably set, for example, to the data amount of an image having the same size as the size of a region corresponding to first partial display region 15A plus second partial display region 15B. If an image has such a size that cannot be displayed at one time in first partial display region 15A and second partial display region 15B, second partial display region 15B is driven, so that the number of times of scrolling can be reduced, thereby improving the operability. Furthermore, in the case where the data amount of an image is smaller than threshold value T4, the user can see the whole image with a few scrolling operations, and therefore power consumption can be reduced without second light source 17 being driven.

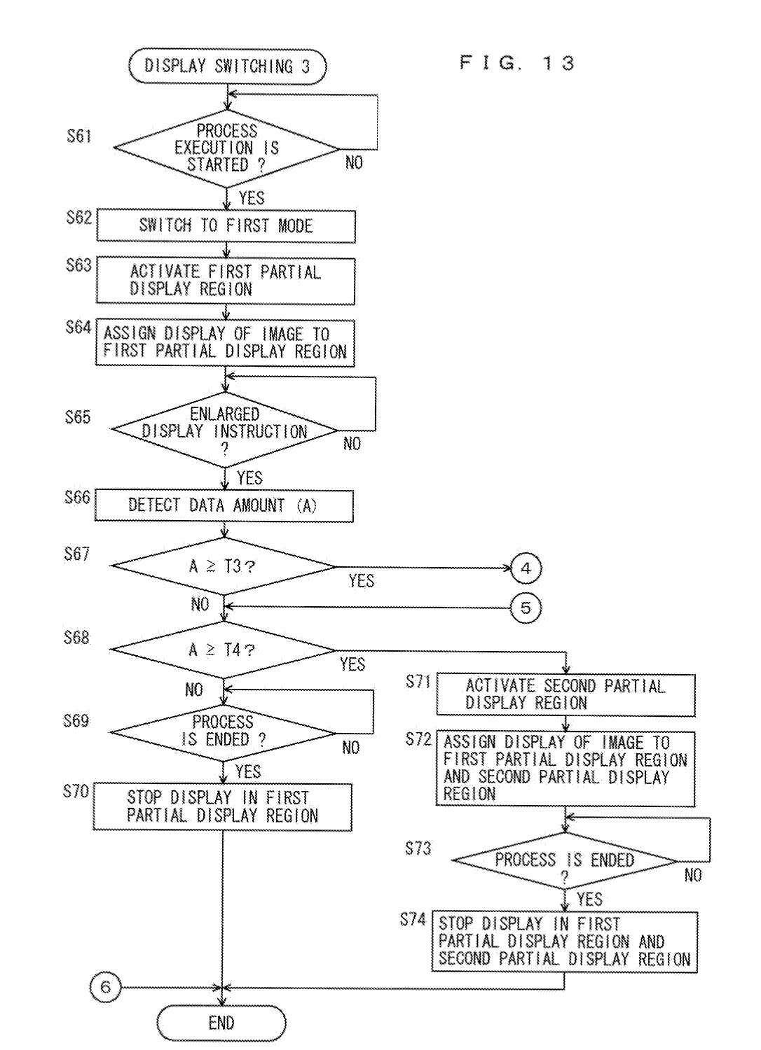

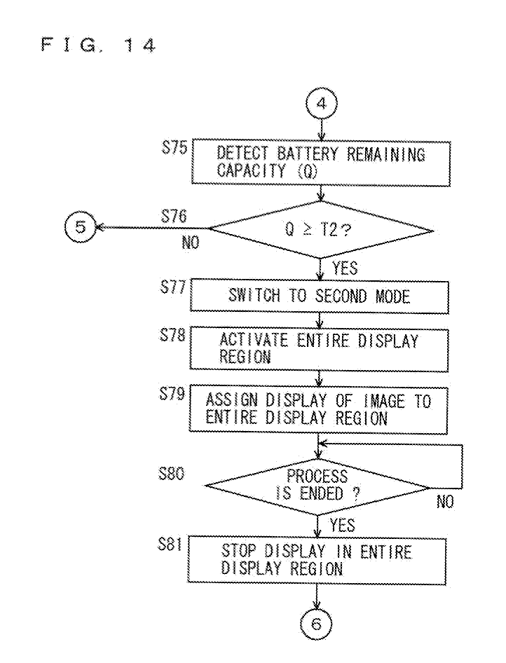

FIG. 13 and FIG. 14 are flowcharts showing an exemplary flow of a display switching process in the second modification. The display switching process in the second modification is a process executed by CPU 21B when CPU 221B executes a display switching program. Referring to FIG. 13 and FIG. 14, CPU 21B determines whether the process has been executed or not (step S61). The process waits until the process is executed (NO in step S61). When the process is executed, the process proceeds to step S62.

In step S62, the display mode is switched to the first mode. In the next step S63, first partial display region 15A is activated. Specifically, first light source 16 is driven. Then, in step S64, an image output by execution of the process is assigned to first partial display region 15A. Accordingly, the image output by execution of the process is visually displayed in first partial display region 15A.

In step S65, it is determined whether an enlarged display instruction is accepted or not. The process waits until an enlarged display instruction is accepted (NO in step S65). When an enlarged display instruction is accepted, the process proceeds to step S66. In step S66, data amount A of the image output by execution of the process is detected. Then, it is determined whether data amount A is equal to or greater than threshold value T3 (step S67). Here, threshold value T3 is set to the same value as the data amount of an image having the same size as the size of the entire display region 15A, 15B, 15C of LCD 15. If data amount A is equal to or greater than threshold value T3, the process proceeds to step S75, and if not, the process proceeds to step S68. In step S68, it is determined whether data amount A is equal to or greater than threshold value T4. If data amount A is equal to or greater than threshold value T4, the process proceeds to step S71, and if not, the process proceeds to step S69.

In step S69, it is determined whether the process is ended or not. The process waits until the process is ended (NO in step S69). If the process is ended (YES in step S69), the process proceeds to step S70. In step S70, display in first partial display region 15A is stopped, and the process ends. Specifically, driving of first light source 16 is stopped.

In step S71, second partial display region 15B is activated. Specifically, second light source 17 is driven. In the next step S72, the image output by execution of the process is assigned to first partial display region 15A and second partial display region 15B. Since first light source 16 and second light source 17 are driven, the image output by execution of the process is visually displayed. As compared with the case where an image is displayed only in first partial display region 15A, the display area is increased so that the image can be displayed in an easily visible manner.

In step S73, it is determined whether the process is ended or not. The process waits until the process is ended (NO in step S73). When the process is ended (YES in step S73), the process proceeds to step S74. In step S74, display of the image in first partial display region 15A and second partial display region 15B is stopped, and the process then ends. Specifically, driving of first light source 16 and second light source 17 is stopped.

On the other hand, in step S75, the remaining capacity Q of battery 37 is detected. Then, it is determined whether the battery remaining capacity Q is equal to or greater than threshold value T2 (step S76). If the remaining capacity Q of battery 37 is equal to or greater than threshold value T2, the process proceeds to step S77, and if not, the process proceeds to step S68. If the remaining capacity of battery 37 is small, the display mode is switched to the first mode, thereby making mobile phone 1 usable as long as possible.

If the remaining capacity Q of battery 37 is equal to or greater than threshold value T2, the display mode is switched to the second mode (step S77). The following process in steps S77 to S81 is the same as the process in steps S55 to S58 in FIG. 10 and therefore a description thereof will not be repeated here.

In the case where the display mode is switched in the first mode, mobile phone 1 in the second modification visually displays an image in first partial display region 15A, and in response to an enlarged display instruction being accepted, visually displays the image that has been displayed in first partial display region 15A, in first partial display region 15A and second partial display region 15B. Therefore, only first light source 16 is driven until an enlarged display instruction is accepted, so that power consumption is reduced. Then, when an enlarged display instruction is accepted, the image is displayed in first partial display region 15A and second partial display region 15B, so that the image can be displayed in an easily visible manner.

Furthermore, it is determined whether an image is to be visually displayed in second partial display region 15B or not, based on the data amount of the image. Therefore, priority between reduction of power consumption and convenience can be determined depending on the data amount.

Furthermore, in the case where the display mode is switched in the first mode, it is switched to the second mode when an enlarged display instruction is accepted, on condition that the data amount of the image is equal to or greater than threshold value T3, so that the image is displayed in the entire display region 15A, 15B, 15C. Therefore, the image can be displayed in an easily visible manner. In addition, priority between reduction of power consumption and convenience can be determined depending on the data amount.

Although in the foregoing embodiment mobile phone 1 has been illustrated as an example of the portable information processing apparatus, any information device such as PDA can be employed as long as it can be carried along. It is needless to say that the present invention can be understood as an image output method for executing the process shown in FIG. 5 to FIG. 7, FIG. 10, or FIG. 13 and FIG. 14, or an image output program for allowing a computer to execute the image output method.

The embodiment disclosed here should be understood as being illustrative rather than being limitative in all respects. The scope of the present invention is shown not in the foregoing description but in the claims, and it is intended that all modifications that come within the meaning and range of equivalence to the claims are embraced here.

1. A portable information processing apparatus comprising:
process execution portion to execute a plurality of processes;
display portion having two or more partial display regions for visually displaying an image:
mode switch portion to switch between a first mode in which an image is visually displayed in at least one of said two or more partial display regions and a second mode in which an image is visually displayed in an entire display region of said display portion; and
display control portion to, if said first mode is switched on, visually displaying a first image output by execution of a first process of said plurality of processes and a second image output by execution of a second process of said plurality, of processes in a first partial display region and a second partial display region, respectively, of said two or more partial display regions.

2. The portable information processing apparatus according to claim 1, wherein if said first mode is switched on, said display control portion visually displays said second image output by execution of said second process in said second display region when said second process is executed before a prescribed time has elapsed since said first image output by execution of said first process is visually, displayed in said first partial display region, and said display control portion visually displays said second image output by execution of said second process in said first partial display region when said second process is executed after said prescribed time has elapsed since said first image output by execution of said first process is visually displayed in said first partial display region.

3. The portable information processing apparatus according to claim 1, further comprising:
a battery; and
remaining capacity detection portion to detecting a remaining capacity of said battery,
wherein said mode switch portion switches to said first mode, if the remaining capacity detected by said remaining capacity detection portion is smaller than a prescribed amount.

4. The portable information processing apparatus according to claim 1, wherein said display control portion includes marking portion to add a prescribed mark to a displayed part of an image when all of the image is not displayed.

5. A portable information processing apparatus comprising:
display portion having a partial display region for visually displaying an image partially;
detection portion to detect a data amount of an image;
mode switch portion to switch between a first mode in which an image is visually displayed in said partial display region and a second mode in which an image is visually displayed in an entire display region of said display means portion, based on said detected data amount; and
display control portion to, if said first mode is switched on, visually displaying an image in said partial display region.

6. The portable information processing apparatus according to claim 5, wherein
said display portion has a plurality of said partial display regions,
said portable information processing apparatus further comprises an instruction accepting portion to accepting an enlarged display instruction by a user, and
if said first mode is switched on, said display control portion visually displays an image in one of said plurality of partial display regions. and in response to said enlarged display instruction being accepted, visually displays an image in at least two of said plurality of partial display regions.

7. The portable information processing apparatus according to claim 5, further comprising:
a battery; and
remaining capacity detection portion to detect a remaining capacity of said battery,
wherein said mode switch portion switches to said first mode, if the remaining capacity detected by said remaining capacity detection portion is smaller than a prescribed amount.

8. The portable information processing apparatus according to claim 5. wherein said display control portion includes marking portion to add a prescribed mark to a displayed part of an image when all of the image is not displayed.

9. A portable information processing apparatus comprising:
display portion having a plurality of partial display regions for visually displaying an image:
mode switch portion to switch between a first mode in which an image is visually displayed in at least one of said plurality of partial display regions and a second mode in which an image is visually displayed in an entire display region of said display portion;
instruction accepting portion to accept an enlarged display instruction by a user; and
display control portion to, if said first mode is switched on, visually display an image in one of said plurality of partial display regions and. in response to said enlarged display instruction being accepted, visually displaying said displayed image in at least two of said plurality of partial display regions.

10. The portable information processing apparatus according to claim 9, further comprising:
a battery; and
remaining capacity detection portion to detecting a remaining capacity of said battery,
wherein said mode switch portion switches to said first mode, if the remaining capacity detected by said remaining capacity detection portion is smaller than a prescribed amount.

11. The portable information processing apparatus according to claim 9, wherein said display control portion includes marking portion to add a prescribed mark to a displayed part of an image when all of the image is not displayed.

12. The portable information processing apparatus according to claim 9, further comprising detection portion to detecting a data amount of an image.
wherein said display control portion determines a partial display region for visually displaying said image among said plurality of partial display regions, based on said detected data amount.

13. The portable information processing apparatus according to claim 9, further comprising detection portion to detecting a data amount of an image,
wherein if said first mode is switched on, said mode switching portion switches to said second mode when said enlarged display instruction is accepted, on condition that said detected data amount is equal to or greater than a prescribed value.

14. An image display method performed in a portable information processing apparatus including display portion having two or more partial display regions for visually displaying an image. said method comprising the steps of:
switching between a first mode in which an image is visually displayed in at least one of said two or more partial display regions and a second mode in which an image is visually displayed in an entire display region of said display portion; and
if said first mode is switched on. visually displaying a first image output by execution of a first process and a second image output by execution of a second process in a first partial display region and a second partial display region, respectively, of said two or more partial display regions.

15. An image display method performed in a portable information processing apparatus including display portion having, a partial display region for visually displaying an image partially, said method comprising the steps of:
detecting a data amount of an image;
switching between a first mode in which an image is visually displayed in said partial display region and a second mode in which an image is visually displayed in an entire display region of said display portion, based on said detected data amount; and
if said first mode is switched on. visually displaying an image in said partial display region.

16. An image display method performed in a portable information processing apparatus including display portion having a plurality of partial display regions for visually displaying an image. said method comprising the steps of:
switching between a first mode in which an image is visually displayed in at least one of said plurality of partial display regions and a second mode in which an image is visually displayed in an entire display region of said display portion:
accepting an enlarged display instruction by a user; and
displaying an image;
wherein said display step includes
a first display step of, if said first mode is switched on. visually displaying an image in at least one of said plurality of partial display regions; and
a second display step of, in response to said enlarged display instruction being accepted when an image is visually displayed in one of said plurality of partial display regions, visually displaying said displayed image in at least two of said plurality of partial display regions.

17. The image display method according to claim 14, wherein said display step includes the steps of
if said first mode is switched on, visually displaying said second image output by execution of said second process in said second display region when said second process is executed before a prescribed time has elapsed since said first image output by execution of said first process is visually displayed in said first partial display region; and
if said first mode is switched on, visually displaying, said second image output by execution of said second process in said first partial display region when said second process is executed after said prescribed time has elapsed since said first image output by execution of said first process is visually displayed in said first partial display region.

18. The image display method according to claim 14, wherein:
said portable information processing apparatus further comprises the battery;
said image display method further includes the step of detecting a remaining capacity of said battery; and
said switching step includes the step of switching to said first mode, if the remaining capacity detected by said step of detecting the remaining capacity is smaller than a prescribed amount.

19. The image display method according to claim 14, wherein said display step includes the step of adding a prescribed mark to a displayed part of an image when all of the image is not displayed.

20. The image display method according to claim 15, wherein:
said display portion has a plurality of said partial display regions;
said image display method further includes the step of accepting an enlarged display instruction by a user; and
said display step includes the steps of, if said first mode is switched on, visually displaying an image in one of said plurality of partial display regions, and in response to said enlarged display instruction being accepted, visually displaying an image in at least two of said plurality of partial display regions.

21. The image display method according to claim 15, wherein:
said portable information processing apparatus further comprises the battery; said image display method further includes the step of detecting a remaining capacity of said battery; and
said switching step includes the step of switching to said first mode, if the remaining capacity detected by said step of detecting the remaining capacity is smaller than a prescribed amount.

22. The image display method according to claim 15, wherein said display step includes the step of adding a prescribed mark to a displayed part of an image when all of the image is not displayed.

23. The image display method according to claim 16, wherein:
said portable information processing apparatus further comprises the battery;
said image display method further includes the step of detecting a remaining capacity of said battery; and
said switching step includes the step of switching to said first mode, if the remaining capacity detected by said step of detecting the remaining capacity is smaller than a prescribed amount.

24. The image display method according to claim 16, wherein said display step includes the step of adding a prescribed mark to a displayed part of an image when all of the image is not displayed.

25. The image display method according to claim 16, further including the step of detecting a data amount of an image,
wherein said display step includes the step of determining a partial display region for visually displaying said image among said plurality of partial display regions, based on said detected data amount.

26. The image display method according to claim 16, further including the step of detecting a data amount of an image,
wherein said display step includes the step of if said first mode is switched on, switching to said second mode when said enlarged display instruction is accepted, on condition that said detected data amount is equal to or greater than a prescribed value.
